(19) United States
(12) Patent Application Publication
(10) Pub. No.: US 2017/0312558 A1
(43) Pub. Date: Nov. 2, 2017

(54) FACEMASK

(71) Applicant: Alex Wang, Ontario, CA (US)

(72) Inventor: Alex Wang, Ontario, CA (US)

(21) Appl. No.: 15/583,908

(22) Filed: May 1, 2017

Related U.S. Application Data
(60) Provisional application No. 62/329,858, filed on Apr. 29, 2016.

(51) Int. Cl. A62B 23/02; A41D 13/11

(52) U.S. Cl. CPC A62B 23/025; A41D 13/1115

(57) ABSTRACT

A facemask includes a breathing area for filtering air; and a compressible gasket formed on a periphery of the breathing area to abut on a user's face; wherein the compressible gasket has a three-dimensional and airtight configuration. A facemask includes a breathing area for filtering air; and a compressible gasket formed on a periphery of the breathing area to abut on a user's face; wherein the compressible gasket comprises a nonwoven first layer to biased against the wearer's face so as to support the three dimensional configuration of the compressible gasket, and a protection thin layer made of airtight material attached on an inner surface of the nonwoven first layer.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a facemask, and more particularly to a facemask which comprises an ergonomic structure compatible for a wide range of face sizes and shapes.

### Description of Related Arts

Conventionally, facemasks, which are able to be used for different face sizes and shapes, have been developed for a long period of time. A common feature of the facemask is that the facemask may include a periphery adapted to abut a user's face. For example, U.S. Pat. No. 8,091,551 relates to a facemask which comprises a compressible gasket on the periphery of the facemask to sit between the periphery of the facemask and a face of a user, and an area for filtering air which is interior to the periphery and not covered by the gasket, wherein the compressible gasket are made of a breathable filtering material. However, such facemasks have several drawbacks.

Since the compressible gasket is formed of the breakable material, the steam from the user's breath may inevitably pass through the compressible gasket. For example, when the users are wearing the facemasks to cover on their mouths and noses, the steam may pass through the compressible gasket while they are breathing and talking. In addition, if the users wear glasses, the steam passed through the compressible gasket is tended to attach on the lens of the glasses, so that the glasses may fog up to block their views. In other words, the users need to wipe off the fog on their glasses frequently in order to clear their views. It is inconvenient and dangerous for the users to frequently take off the glasses and then wiping off the fog on the glasses, and especially for using the facemasks to operate precision-required jobs.

Accordingly, when the medical staff are using the facemasks in the operating room, it is very dangerous while the fog is generated on the glasses wearing by the medical staffs, and some medical negligence may unfortunately happen. Furthermore, when lab staffs are wearing the facemasks in the laboratory, some hazardous substance may retain on their hands, so the hazardous substance is attached on their glasses while the lab staffs want to take off the glasses to wipe off the fog, and then the skin of the lab staffs will be polluted by the hazardous. Therefore, there remains a need for a new and improved facemask to overcome the problems stated above.

### SUMMARY OF THE PRESENT INVENTION

The invention is advantageous in that it provides a facemask having a compressible gasket adapted to abut the wear's face, wherein the compressible gasket has airtight configuration to prevent unfiltered air and the steam passed therethrough.

Another advantage of the invention is to provide a facemask which comprises a breathing area having a three dimensional configuration to conform the contour of the wear's face.

Another advantage of the invention is to provide a facemask, wherein the compressible gasket has a three-dimensional configuration in order to support the inner periphery of the compressible gasket being sealedly covered on the wear's face.

Another advantage of the invention is to provide a facemask, wherein the compressible gasket comprises not only a thicker nonwoven layer to support the three dimensional configuration, but also a protection thin layer attached on an inner surface of the thicker nonwoven layer to provide unfiltered steam and air passed therethrough.

Another advantage of the invention is to provide a facemask which comprises a three filtering layers and one protection layer, so as to not only provide a high filtering efficiency, but also provide a more comfortable fit for the facemask.

Another advantage of the invention is to provide a facemask, wherein no expansive or complicated structure is required to employ in the present invention in order to achieve the above mentioned advantages. Therefore, the present invention successfully provides an economics and efficient solution for providing more safety and comfortable facemask without affecting the main structure of the facemasks

Additional advantages and features of the invention will become apparent from the description which follows, and may be realized by means of the instrumentalities and combinations particular point out in the appended claims.

According to the present invention, the foregoing and other objects and advantages are attained by a facemask, comprising:

a breathing area for filtering air; and

a compressible gasket formed on a periphery of the breathing area to abut on a user's face; wherein the compressible gasket has a three-dimensional and airtight configuration.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a facemask according to a preferred embodiment of the present invention.

FIG. 2 is a perspective view of a facemask according to the above preferred embodiment of the present invention, illustrating a breathing area being expended to form a three dimensional configuration.

FIG. 3 is a perspective view of a facemask according to the above mentioned preferred embodiment of the present invention, illustrating that the facemask is donned by the wearer.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

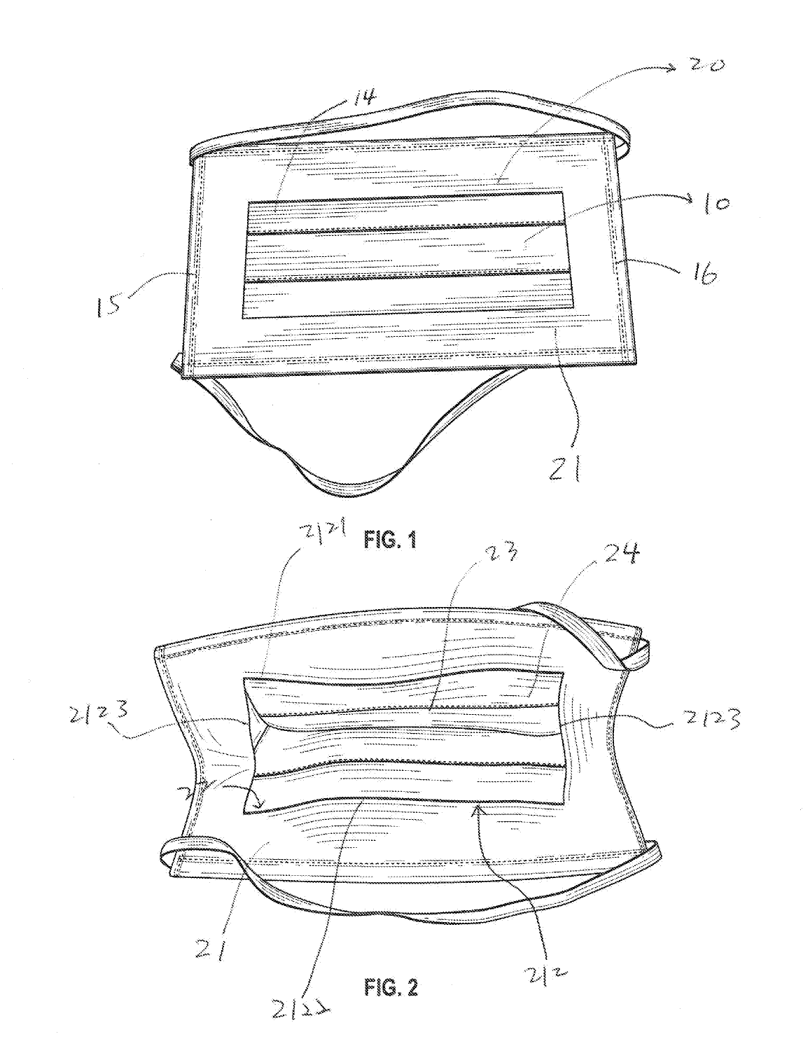

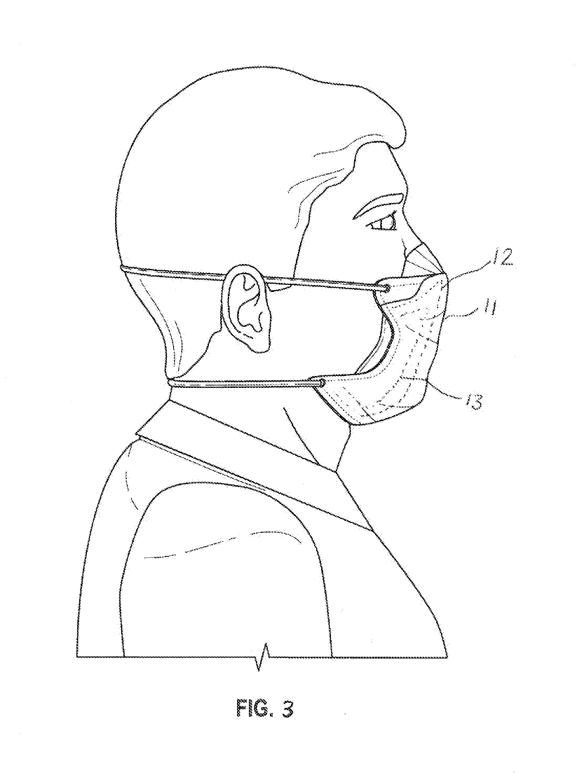

Referring to FIGS. 1 and 2 of the drawings, a facemask according to one embodiment of the present invention is illustrated, wherein the facemask comprises a breathing area 10 for filtering air and a compressible gasket 20 attached on a periphery of the breathing area 10 to abut a user's face, wherein the compressible gasket 20 has an airtight configuration.

As shown in FIG. 3, the breathing area 10 comprises an outer layer 11, an intermediate layer 12, and an inner layer 13, wherein the outer layer 11, the intermediate layer 12, and the inner layer 13 are edge-to-edge sealed with each other to define the outer surface of the facemask. In one embodiment, the outer layer 11 can be made of non-woven, liquid-resistant, polypropylene fabric designed to be the first contact filter barrier layer against body fluids and liquid particulate contaminants from outside the facemask mask. The intermediate layer 12 can be made of nonwoven, liquid-resistant, melt blown, polypropylene designed to act as a barrier against bacteria, body fluids, and particulate contaminants such as different kinds of dust particles, in order to fulfill a N95 facemask criteria. The inner layer 13 is designed to come in contact with the wearer's face and is made of nonwoven material that is resistant to liquid and designed to be soft; and the inner layer 13 has good moisture absorbing properties to increase the comfort and durability of the facemask.

Accordingly, the breathing area 10 further comprises a plurality of folded pleats 14 oriented horizontally with respect to the face of the wearer. A first seam 15 and a second seam 16 are formed along the lateral sides of breathing area 10 and between the pleats 14 in order to prevent the pleats 14 from separating at the edges. Preferably, the first seams 15 and the second seams 16 can be formed by sew bonding or heat bonding techniques. Therefore, the pleats 14 are adapted to be expanded to cover the faces of the wearers. In other words, after the pleats 14 are expanded, a three dimensional and cup-like configuration of the breathing area 10 is provided for proving breathing along with a more comfortable fit.

The compressible gasket 20 is a loop and strip-like structure, and the compressible gasket 20 comprises a polypropylene nonwoven first layer 21 comprising an outer periphery 211 adapted to attach on the periphery of the breathing area 10 by sew or heat bonding techniques to define a receiving cavity 23, an inner periphery 212, and an opening 24 defined on the inner periphery 212. In addition, the inner periphery 212 is designed as an ergonomic shape adapted to conform to the edge of the wear's faces to form a three dimensional configuration. Furthermore, the inner periphery 212 comprises an upper edge 2121 designed to compatible with a bright of the user's nose, a bottom edge 2122 designed to compatible with a chine of the users, and two side edges 2123 designed to compatible with a contour of the user's cheek. That is to say, while the facemask is donned, the inner periphery 212 can be closely attached on the contour of the wearer's face to form an airtight seal, and the breathing area 10 can be expanded to form the three dimensional configuration. Meanwhile, the wear's mouth and nose portion are deposed inside the receiving cavity 23 through the opening 24. It is worth to mention that the nonwoven first layer 11 has a thickness within a range from about 2 mm to about 2.5 mm, which is configured to retain the three dimensional configuration of the compressible gasket 20 while the compressible gasket 20 is attached to against the contour the wear's face, as shown in FIG. 3.

The compressible gasket 20 further comprises a second protection thin film 22 attached on an inner surface of the nonwoven first layer 21, wherein the second protection thin film 22 can be made of airtight materials, so the second protection thin film 22 can provide an airtight configuration for the compressible gasket 20. It is worth mentioning that the second protection thin film 22 can also be made of waterproof materials to provide a waterproof function for the compressible gasket 20.

Since the compressible gasket 20 of the facemask is the three dimensional and ergonomic configuration, the facemask can be closely covered on the wear's face. In addition, the second protection thin film 22 not only has an airtight capability, but also a waterproof capability for the compressible gasket 20. Therefore, the compressible gasket 20 can not only effectively prevent air passing therethrough, but also can minimize a size of a gap generated between the inner periphery 212 of the compressible gasket 20 and the wear's face, so as to provide a more safety protection.

### Experimental Examples

The facemasks prepared according to one embodiment of the present invention is tested for particle penetration, airflow resistance and inhalation and exhalation resistance. The breathing area 10 of the facemask in the present invention is tested which comprises the outer nonwoven polypropylene layer 11, the inner nonwoven polypropylene layer 12, and the intermediate melt blown layer 13.

Particle Penetration and Airflow Resistance

We wanted to determine whether facemasks produced in accordance with the present invention are N95 respirators and surgical facemasks. The breathing area 10 of the facemask that filters out at least 95% of airborne particles. There are nine classes of NIOSH-approved particulate filtering respirators available at this time. 95% is the minimal level of filtration that will be approved by NIOSH. Testing protocols improved with gaining N95 approval are well-known.

To determine the particle penetration and airflow resistance of the facemask of the present invention, the facemask is tested for particle penetration against a polydispersed, sodium chloride (NaCl) particulate aerosol. The sodium chloride aerosol is dried, neutralized, and passed through the breathing area 10 of the facemasks at a concentration not exceeding 200 mg/m³. The NaCl aerosol is flowed through the breathing area 10 of the facemask at a continuous air flow rate of 85±4 L/min. The testing is performed as specified in 42CFR Part 84 and TEB-APR-STP-0059 for the requirement on a N95 respirator. The TSI CERTITEST Model 8130 Automated Filter Tester 8130 is used to generate the data.

Two series of the facemasks are tested. One series is characterized as a respirator facemask. The other series is characterized as surgical facemasks. The results from the respirator facemask series are shown in Table 1, and the results from the surgical facemask series are shown in Table 2,

TABLE 1
Measure of Filtration Efficiency of the Respirator Facemasks

| Test | Initial Airflow | Particle | Filtration |
|---|---|---|---|
| Article | Resistance | Penetration | Efficiency |
| Number | (mm H2O) | (%) | (%) |
| 1 | 6.9 | 1.02 | 98.98 |
| 2 | 6.8 | 1.23 | 98.77 |
| 3 | 6.8 | 1.24 | 98.76 |
| 4 | 7.0 | 1.08 | 98.92 |
| 5 | 6.6 | 1.12 | 98.88 |
| 6 | 7.3 | 1.12 | 98.88 |
| 7 | 7.1 | 1.03 | 98.97 |
| 8 | 6.6 | 1.13 | 98.87 |
| 9 | 7.4 | 1.06 | 98.94 |
| 10 | 6.9 | 1.17 | 98.83 |
| 11 | 6.8 | 1.18 | 98.82 |
| 12 | 7.1 | 1.25 | 98.75 |
| 13 | 7.5 | 1.14 | 98.86 |
| 14 | 7.5 | 1.44 | 98.56 |
| 15 | 7.4 | 1.10 | 98.90 |
| 16 | 7.2 | 1.37 | 98.63 |
| 17 | 7.2 | 1.23 | 98.77 |
| 18 | 6.9 | 1.36 | 98.64 |
| 19 | 7.7 | 1.26 | 98.74 |
| 20 | 7.3 | 1.25 | 98.75 |

TABLE 2
Measure of Filtration Efficiency of the Surgical Facemasks

| | Initial Airflow | Particle | Filtration |
|---|---|---|---|
| Test Article | Resistance | Penetration | Efficiency |
| Number | (mm H2O) | (%) | (%) |
| 1 | 5.6 | 0.876 | 99.124 |
| 2 | 6.1 | 1.20 | 98.80 |
| 3 | 5.7 | 1.03 | 98.97 |

As shown in Table 1 for the respirator facemask, on average, less than 2.0% of the NaCl particles penetrates through the facemasks. And, the filtration efficiency, on average, are more than 95.0%. The NIOSH N95 filter efficiency as stated in 42 CFR Part 84.181 is a minimum efficiency for each filter of ≧95%. In other words, less than 5% of the NaCl penetration is permitted. Therefore, the respirator facemasks of the present invention conform to the NIOSH N95 criteria for filter efficiency.

As shown in Table 2 for the surgical facemask, on average, less than 2.0% of the NaCl particles penetrates through the facemasks. And, the filtration efficiency, on average, are more than 95.0%. Therefore, the surgical facemask of the present invention also conform to the NIOSH N95 criteria for filter efficiency.

Tests are also conducted to determine inhalation and exhalation resistance of the facemasks of the present invention. The air exchange differential or breathability of respirators is measured for inhalation resistance using NIOSH procedure TEB-APR-STP-0007 and exhalation resistance with NIOSH procedure TEB-APR-STP-0003. The inhalation resistance criteria as stated in 42 CFR Part 84.180 is an initial inhalation not exceeding 35 mm water column height pressure. The exhalation resistance criteria as stated in 42 CFR Part 84.180 is an initial exhalation not exceeding 25 mm water column height pressure. Results of inhalation and exhalation resistance testing for facemasks of the present invention are shown in Table 3.

TABLE 3
Measure of Inhalation and Exhalation Resistance of the facemasks

| | Inhalation | Exhalation |
|---|---|---|
| Test Article | Resistance | Resistance |
| Number | (mm H2O) | (mm H2O) |
| 1 | 4.4 | 4.6 |
| 2 | 4.4 | 4.6 |
| 3 | 4.4 | 4.6 |
| Mean | 4.4 | 4.4 |

As shown in table 3, the mean inhalation resistance for the facemasks of the present invention is 4.4, and the mean exhalation resistance for the facemask of the present invention is 4.6. The inhalation resistance and exhalation resistance for the facemask is below the exhalation resistance criteria and inhalation resistance criteria as stated in 42 CFR Part 84.180. Therefore, the facemask of the present invention not only provide a high filtration efficiency, but also are easy to breathe through.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A facemask comprises a breathing area for filtering air and a compressible gasket attached on a periphery of the breathing area to abut a user's face and having has three-dimensional airtight configuration, wherein the breathing area comprises an outer layer, an intermediate layer and an inner layer that are edge-to-edge sealed with each other to define the outer surface of the facemask.

2. The facemask of claim 1, wherein the outer layer can be made of non-woven, liquid-resistant, polypropylene fabric designed to be the first contact filter barrier layer against body fluids and liquid particulate contaminants from outside the facemask mask.

3. The facemask of claim 1, wherein the intermediate layer can be made of nonwoven, liquid-resistant, melt blown, polypropylene designed to act as a barrier against bacteria, body fluids, and particulate contaminants.

4. The facemask of claim 1, wherein the inner layer is designed to come in contact with the wearer's face and is made of nonwoven material that is resistant to liquid and designed to be soft, and the inner layer has good moisture absorbing properties to increase the comfort and durability of the facemask.

5. The facemask of claim 1, wherein the breathing area further comprises a plurality of folded pleats oriented horizontally with respect to the face of the wearer, and a first seam and a second seam are formed along the lateral sides of breathing area and between the pleats in order to prevent the pleats from separating at the edges.

6. The facemask of claim 1, wherein compressible gasket comprises a polypropylene nonwoven first layer comprising an outer periphery adapted to attach on the periphery of the breathing area by sew or heat bonding techniques to define a receiving cavity, an inner periphery, and an opening defined on the inner periphery.

7. The facemask of claim 6, wherein the nonwoven first layer has a thickness within a range from about 2 mm to about 2.5 mm, which is configured to retain the three-dimensional configuration of the compressible gasket.

8. The facemask of claim 6, wherein the inner periphery comprises an upper edge configured to compatible with a bright of the user's nose, a bottom edge configured to compatible with a chine of the users, and two side edges configured to compatible with a contour of the user's cheek.
